(19) United States
(12) Patent Application Publication
(10) Pub. No.: US 2023/0176602 A1
(43) Pub. Date: Jun. 8, 2023

(54) LINEAR POWER SUPPLY

(71) Applicant: ROHM Co., LTD., Kyoto (JP)

(72) Inventor: Hiroki Inoue, Kyoto (JP)

(21) Appl. No.: 18/060,636

(22) Filed: Dec. 1, 2022

(30) Foreign Application Priority Data
Dec. 2, 2021 (JP) 2021-195987

(51) Int. Cl. G05F 1/575

(52) U.S. Cl. CPC G05F 1/575

(57) ABSTRACT

Provided is a linear power supply including a feedback resistor, an output transistor and a drive target transistor that are configured to be connected in series between an application end of an input voltage and the feedback resistor, an error amplifier configured to drive the output transistor based on an error between a reference voltage and a feedback voltage that is generated by the feedback resistor based on an output voltage, and a drive circuit configured to drive the drive target transistor in an on-state all the time.

### CROSS REFERENCE TO RELATED APPLICATIONS

This application claims priority benefit of Japanese Patent Application No. JP 2021-195987 filed in the Japan Patent Office on Dec. 2, 2021. Each of the above-referenced applications is hereby incorporated herein by reference in its entirety.

### BACKGROUND

The present disclosure relates to a linear power supply.

In the past, a linear power supply (linear regulator) that can generate a desirable output voltage from an input voltage has been mounted on various applications (such as in-vehicle devices, industrial equipment, business equipment, digital appliances, and portable devices) (an example of the linear power supply is disclosed in Japanese Patent Laid-Open No. 2020-201562).

### SUMMARY

The linear power supply includes an output transistor (power transistor) that receives the input voltage. The output transistor needs to correspond to a high breakdown voltage, and the size of the output transistor is basically large. Therefore, the parasitic capacitance at a gate of the output transistor becomes large, and the change rate of a gate voltage in charging and discharging the gate is reduced. As a result, high frequency characteristics are not obtained.

In view of the circumstances, it is desirable to provide a linear power supply that can obtain high frequency characteristics.

For example, a linear power supply according to an embodiment of the present disclosure includes a feedback resistor, an output transistor and a drive target transistor that are configured to be connected in series between an application end of an input voltage and the feedback resistor, an error amplifier configured to drive the output transistor based on an error between a reference voltage and a feedback voltage that is generated by the feedback resistor based on an output voltage, and a drive circuit configured to drive the drive target transistor in an on-state all the time.

With the linear power supply according to the embodiment of the present disclosure, high frequency characteristics can be obtained.

### BRIEF DESCRIPTION OF THE DRAWINGS

FIG. 1 depicts a configuration of a linear power supply according to a comparative example;

FIG. 2 depicts a configuration of a linear power supply according to a first embodiment;

FIG. 3 depicts a configuration of a linear power supply according to a second embodiment;

FIG. 4 depicts a configuration of a linear power supply according to a third embodiment;

FIG. 5 depicts a configuration of a linear power supply according to a fourth embodiment;

FIG. 6 depicts a configuration of a linear power supply according to a fifth embodiment; and

FIG. 7 depicts a configuration of a linear power supply according to a sixth embodiment.

### DETAILED DESCRIPTION OF THE PREFERRED EMBODIMENTS

### 1. Comparative Example

A comparative example compared with a novel embodiment of a linear power supply will be described here before the novel embodiment is described.

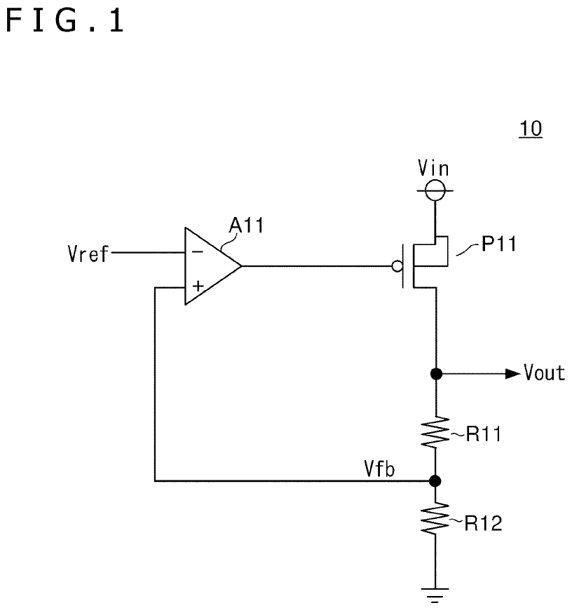

FIG. 1 depicts a configuration of a linear power supply 10 according to the comparative example. The linear power supply 10 is a linear regulator that steps down an input voltage Vin to generate a desirable output voltage Vout. The linear power supply 10 includes an output transistor P11, feedback resistors R11 and R12, and an error amplifier A11.

A source and a back gate of the output transistor P11 including P-channel metal-oxide-semiconductor field-effect transistor (MOSFET), i.e., a PMOS transistor, are connected to an application end of the input voltage Vin. A drain of the output transistor P11 and a first end of the feedback resistor R11 are connected in common to an output end for outputting the output voltage Vout. A second end of the feedback resistor R11 is connected to a first end of the feedback resistor R12. A second end of the feedback resistor R12 is connected to a ground end.

A non-inverting input end (+) of the error amplifier A11 is connected to a connection node (= application end of feedback voltage Vfb) at which the feedback resistors R11 and R12 are connected to each other. An inverting input end (−) of the error amplifier A11 is connected to an application end of a reference voltage Vref. An output end of the error amplifier A11 is connected to a gate (control end) of the output transistor P11.

The error amplifier A11 controls the gate of the output transistor P11 to bring the feedback voltage Vfb (=Vout ×{R12/(R11+R12)}) corresponding to the output voltage Vout into line with a predetermined reference voltage Vref. That is, the on-resistance value of the output transistor P11 is continuously controlled to bring the output voltage Vout into line with a target value (=Vref×{(R11+R12)/R12}) of the output voltage Vout.

A voltage corresponding to the difference between the input voltage Vin (for example, 45 V) and the output voltage Vout (for example, 5 V) is applied between the source and the drain of the output transistor P11, and the output transistor P11 needs to include a high breakdown voltage element. The distance between the drain and the source is long in the high breakdown voltage element due to the structure of the element, and the size of the high breakdown voltage element is basically large. Therefore, the parasitic capacitance at the gate of the output transistor P11 becomes large, and the change rate of a gate voltage in charging and discharging the gate is reduced. There is a problem that high frequency characteristics are not obtained.

### 2. First Embodiment

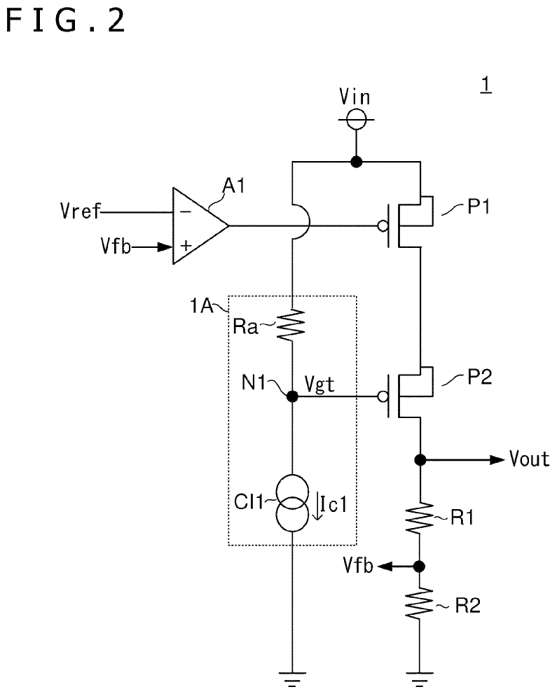

Various embodiments that can solve the problem will be described. FIG. 2 depicts a configuration of a linear power supply 1 according to a first embodiment. The linear power supply 1 includes an output transistor P1, a PMOS transistor (drive target transistor) P2, feedback resistors R1 and R2, an error amplifier A1, and a drive circuit 1A.

The linear power supply 1 is a linear regulator that steps down an input voltage Vin to generate a desirable output voltage Vout.

A source and a back gate of the output transistor P1 including a PMOS transistor are connected to an application end of the input voltage Vin. A drain of the output transistor P1 is connected to a source and a back gate of the PMOS transistor P2. A drain of the PMOS transistor P2 and a first end of the feedback resistor R1 are connected in common to an output end for outputting the output voltage Vout. A second end of the feedback resistor R1 is connected to a first end of the feedback resistor R2. A second end of the feedback resistor R2 is connected to a ground end. That is, the output transistor P1 and the PMOS transistor P2 are connected in series between the application end of the input voltage Vin and the feedback resistor R1.

A non-inverting input end (+) of the error amplifier A1 is connected to a connection node (= application end of feedback voltage Vfb) at which the resistors R1 and R2 are connected to each other. An inverting input end (−) of the error amplifier A1 is connected to an application end of a reference voltage Vref. An output end of the error amplifier A1 is connected to a gate of the output transistor P1.

The drive circuit 1A drives a gate of the PMOS transistor P2. Specifically, the drive circuit 1A includes a resistor Ra and a constant current source CI1. A first end of the resistor Ra is connected to the application end of the input voltage Vin. The constant current source CI1 is connected to a second end of the resistor Ra and the ground end. That is, the resistor Ra and the constant current source CI1 are connected in series between the application end of the input voltage Vin and the ground end. A node N1 at which the second end of the resistor Ra and the constant current source CI1 are connected to each other is connected to the gate of the PMOS transistor P2. A gate voltage Vgt generated at the node N1 drives the gate of the PMOS transistor P2. The gate voltage Vgt is a voltage equal to the input voltage Vin minus the voltage drop at the resistor Ra which is caused by a constant current Ic1 flowing in the constant current source CI1.

The error amplifier A1 drives the gate of the output transistor P1 based on an error between the feedback voltage Vfb and the reference voltage Vref. The gate voltage Vgt generated by the drive circuit 1A drives the PMOS transistor P2 in an on-state all the time during the operation of the linear power supply 1.

It is assumed that the input voltage Vin is 45 V and that the output voltage Vout is 5 V, for example. Assuming that the voltage drop at the resistor Ra is 5 V, the gate voltage Vgt is equal to 40 V. Assuming that a threshold voltage Vth of Vgs (gate-source voltage) of the PMOS transistor P2 is equal to 1 V, a source voltage of the PMOS transistor P2 is controlled at approximately 42 V.

Therefore, a voltage of approximately 3 V is applied between the source and the drain of the output transistor P1, and the output transistor P1 can include a low breakdown voltage element with a breakdown voltage lower than that of the output transistor P11 in the comparative example. A voltage between the source voltage of the PMOS transistor P2 and the output voltage Vout is applied between the source and the drain of the PMOS transistor P2, and the PMOS transistor P2 needs to include a high breakdown voltage element with approximately the same breakdown voltage as that of the output transistor P11 in the comparative example.

Preferably, the output transistor P1 includes, for example, a complementary MOSFET (CMOS) as a low breakdown voltage element. Preferably, the PMOS transistor P2 includes, for example, a double-diffused MOSFET (DMOS) as a high breakdown voltage element.

According to the present embodiment, the output transistor P1 can include a low breakdown voltage element. Therefore, the parasitic capacitance at the gate of the output transistor P1 can be reduced, and high frequency characteristics can be obtained. Note that the source voltage of the PMOS transistor P2 is changed when the output transistor P1 is driven, and the charge of Cgs (gate-source capacitance) of the PMOS transistor P2 is controlled.

Although the PMOS transistor P2 needs to include a high breakdown voltage element in such a size that secures the current capability, the PMOS transistor P2 is driven in the on-state all the time, and the size can be smaller than the size of the output transistor P11 in the comparative example.

In the present embodiment, the drive circuit 1A functions as a clamp circuit that generates the gate voltage Vgt to clamp Vgs of the PMOS transistor P2. The constant current source CI1 stabilizes the gate voltage Vgt, and the clamp function is thus stabilized. Note that a clamp element such as a Zener diode may be connected to the gate and the source of the PMOS transistor P2.

### 3. Second Embodiment

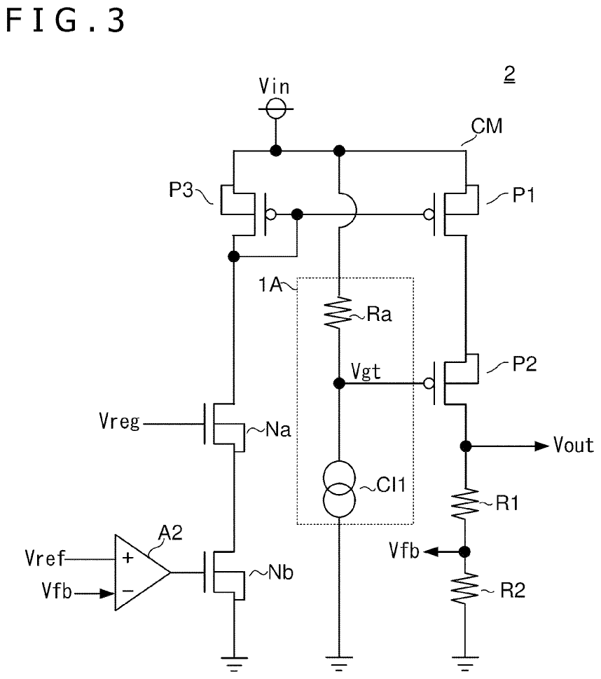

FIG. 3 depicts a configuration of a linear power supply 2 according to a second embodiment. Compared to the configuration of the first embodiment, the linear power supply 2 includes an error amplifier A2 in place of the error amplifier A1 and further includes a PMOS transistor P3 and N-channel MOSFETs, i.e., NMOS transistors, Na and Nb.

In the linear power supply 2, the PMOS transistor P3 on the input side and the output transistor (PMOS transistor) P1 on the output side provide a current mirror CM. A gate and a drain of the PMOS transistor P3 are short-circuited. The gate of the PMOS transistor P3 is connected to the gate of the output transistor P1. A source and a back gate of the PMOS transistor P3 are connected to the application end of the input voltage Vin.

A drain of the NMOS transistor Na is connected to the drain of the PMOS transistor P3. A source of the NMOS transistor Na is connected to a drain of the NMOS transistor Nb. A source of the NMOS transistor Nb is connected to the ground end. A gate of the NMOS transistor Na is connected to an application end of a predetermined internal voltage Vreg (for example, 5 V).

An inverting input end (−) of the error amplifier A2 is connected to the connection node (= application end of feedback voltage Vfb) at which the feedback resistors R1 and R2 are connected to each other. A non-inverting input end (+) of the error amplifier A2 is connected to the application end of the reference voltage Vref. An output end of the error amplifier A2 is connected to a gate of the NMOS transistor Nb.

The error amplifier A2 drives the gate of the NMOS transistor Nb based on an error between the feedback voltage Vfb and the reference voltage Vref. A current flowing through the PMOS transistor P3 and the NMOS transistors Na and Nb is mirrored by the current mirror CM and output as a current flowing through the output transistor P1.

In the present embodiment, the NMOS transistor Nb includes a low breakdown voltage element, and the internal voltage Vreg is applied to the gate of the NMOS transistor Na. The gate and the drain of the PMOS transistor P3 are short-circuited, and a voltage in a level of Vgs is applied between the source and the drain of the PMOS transistor P3. Therefore, the PMOS transistor P3 includes a low breakdown voltage element, and the NMOS transistor Na includes a high breakdown voltage element. Note that the NMOS transistor Na is not necessary when the NMOS transistor Nb includes a high breakdown voltage element.

Advantageous effects similar to the advantageous effects of the first embodiment can be obtained in the present embodiment.

### 4. Third Embodiment

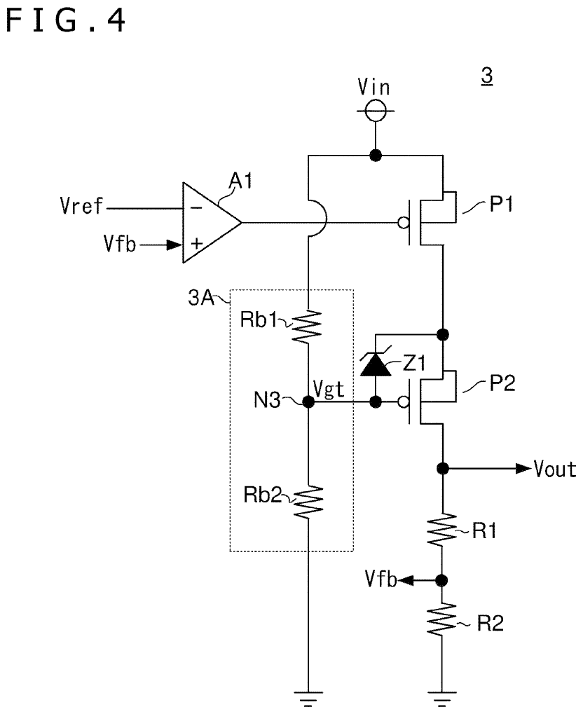

FIG. 4 depicts a configuration of a linear power supply 3 according to a third embodiment. The difference from the first embodiment is that the linear power supply 3 includes a drive circuit 3A in place of the drive circuit 1A in order to drive the PMOS transistor P2 and includes a Zener diode Z1.

The drive circuit 3A includes voltage divider resistors Rb1 and Rb2. A first end of the voltage divider resistor Rb1 is connected to the application end of the input voltage Vin. A second end of the voltage divider resistor Rb1 is connected to a first end of the voltage divider resistor Rb2. A second end of the voltage divider resistor Rb2 is connected to the ground end. That is, the voltage divider resistors Rb1 and Rb2 are connected in series between the application end of the input voltage Vin and the ground end. A node N3 at which the voltage divider resistors Rb1 and Rb2 are connected to each other is connected to the gate of the PMOS transistor P2.

A voltage obtained by the voltage divider resistors Rb1 and Rb2 dividing the input voltage Vin is applied as the gate voltage Vgt to the gate of the PMOS transistor P2, and the PMOS transistor P2 is driven.

To use the gate voltage Vgt to clamp Vgs of the PMOS transistor P2, the input voltage Vin is set to 45 V, and the resistors Rb1 and Rb2 are set such that Rd1:Rd2=1:9, for example. However, assuming that Vth of the PMOS transistor P2 is equal to 1 V in this case, the PMOS transistor P2 is not driven if the input voltage Vin is lower than 10 V. Therefore, the operation range of the input voltage Vin is wider in the first embodiment.

However, for example, Rb1:Rb2=1:1 is set in the present embodiment. The PMOS transistor P2 is made not to be driven if the input voltage Vin is lower than 2 V, and protection from the voltage reduction of the input voltage Vin can be provided. In this case, the Zener diode Z1 as an example of a clamp element can be connected to the gate and the source of the PMOS transistor P2 to clamp Vgs of the PMOS transistor P2.

### 5. Fourth Embodiment

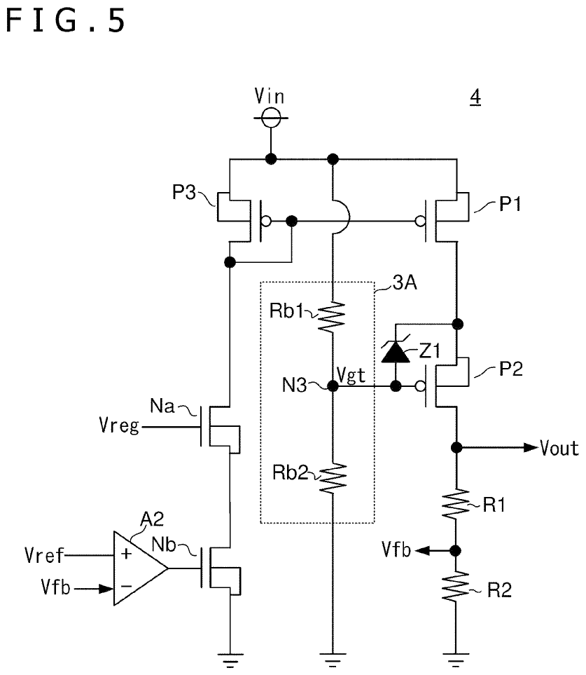

FIG. 5 depicts a configuration of a linear power supply 4 according to a fourth embodiment. The difference from the second embodiment is that the linear power supply 4 includes the drive circuit 3A in place of the drive circuit 1A and includes the Zener diode Z1. The drive circuit 3A and the Zener diode Z1 are similar to those of the third embodiment. According to the present embodiment, advantageous effects similar to the advantageous effects of the third embodiment can be obtained.

### 6. Fifth Embodiment

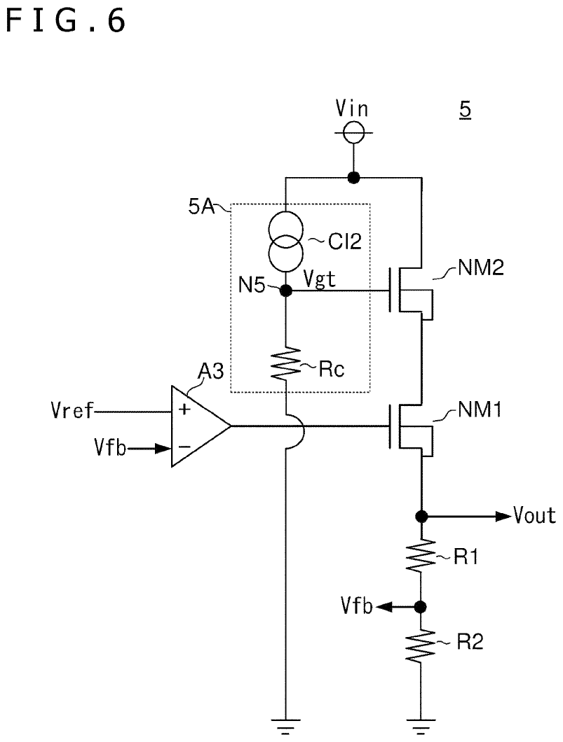

FIG. 6 depicts a configuration of a linear power supply 5 according to a fifth embodiment. The linear power supply 5 includes an output transistor NM1, an NMOS transistor (drive target transistor) NM2, the feedback resistors R1 and R2, an error amplifier A3, and a drive circuit 5A.

The output transistor NM1 includes an NMOS transistor. A drain of the output transistor NM1 is connected to a source of the NMOS transistor NM2. A drain of the NMOS transistor NM2 is connected to the application end of the input voltage Vin. A source of the output transistor NM1 is connected to the first end of the feedback resistor R1. The second end of the feedback resistor R1 is connected to the first end of the feedback resistor R2. The second end of the feedback resistor R2 is connected to the ground end. That is, the output transistor NM1 and the NMOS transistor NM2 are connected in series between the application end of the input voltage Vin and the feedback resistor R1.

An inverting input end (−) of the error amplifier A3 is connected to the connection node (= application end of feedback voltage Vfb) at which the feedback resistors R1 and R2 are connected to each other. A non-inverting input end (+) of the error amplifier A3 is connected to the application end of the reference voltage Vref. An output end of the error amplifier A3 is connected to a gate of the output transistor NM1.

The drive circuit 5A drives a gate of the NMOS transistor NM2. The drive circuit 5A includes a constant current source CI2 and a resistor Rc. A first end of the resistor Rc is connected to the ground end. The constant current source CI2 is connected to the application end of the input voltage Vin and a second end of the resistor Rc. A node N5 at which the resistor Rc and the constant current source CI2 are connected to each other is connected to the gate of the NMOS transistor NM2. A voltage drop at the resistor Rc which is caused by a constant current flowing in the constant current source CI2 generates the gate voltage Vgt at the node N5. The gate of the NMOS transistor NM2 is driven by the gate voltage Vgt.

According to the present embodiment, the output transistor NM1 can include a low breakdown voltage element, and high frequency characteristics can be obtained. Although the NMOS transistor NM2 needs to include a high breakdown voltage element, the gate voltage Vgt drives the NMOS transistor NM2 in the on-state all the time, and the size of the NMOS transistor NM2 can be suppressed.

The constant current source CI2 can stabilize the gate voltage Vgt, and the clamp of Vgs of the NMOS transistor NM2 can be stabilized.

### 7. Sixth Embodiment

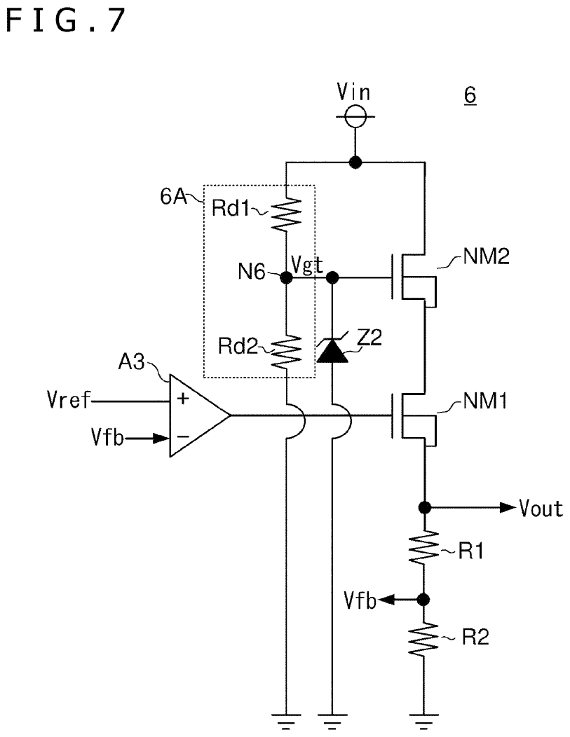

FIG. 7 depicts a configuration of a linear power supply 6 according to a sixth embodiment. The difference from the fifth embodiment is that the linear power supply 6 includes a drive circuit 6A in place of the drive circuit 5A and includes a Zener diode Z2.

The drive circuit 6A includes voltage divider resistors Rd1 and Rd2. The voltage divider resistors Rd1 and Rd2 are connected in series between the application end of the input voltage Vin and the ground end. A node N6 at which the voltage divider resistors Rd1 and Rd2 are connected to each other is connected to the gate of the NMOS transistor NM2. The input voltage Vin is divided by the voltage divider resistors Rd1 and Rd2, and the gate voltage Vgt is generated at the node N6. The gate of the NMOS transistor NM2 is driven by the gate voltage Vgt.

According to the present embodiment, the resistors Rd1 and Rd2 can be set such that Rd1:Rd2=1:1, and Vth of the NMOS transistor NM2 can be set to 1 V as in the third embodiment, for example. In this way, the NMOS transistor NM2 is not driven when the input voltage Vin is lower than 2 V. Therefore, protection from the voltage reduction of the input voltage Vin can be provided. Further, the Zener diode Z2 as an example of a clamp element is connected to the gate of the NMOS transistor NM2 and the ground end, and Vgs of the NMOS transistor NM2 can thus be clamped.

### 8. Others

Various technical features according to the embodiments of the present disclosure can be changed in various ways without departing from the embodiments and the scope of the technical creation of the embodiments. That is, the embodiments are illustrative in all aspects and should not be construed as restrictive. The technical scope of the present technology is not limited to the embodiments, and it should be understood that all changes within the meaning and range of equivalents of the claims are included in the technical scope of the present technology.

### 9. Appendix

As described above, for example, a linear power supply (1) according to the embodiment of the present disclosure includes a feedback resistor (R1), an output transistor (P1) and a drive target transistor (P2) that are configured to be connected in series between an application end of an input voltage (Vin) and the feedback resistor, an error amplifier (A1) configured to drive the output transistor based on an error between a reference voltage (Vref) and a feedback voltage (Vfb) that is generated by the feedback resistor based on an output voltage (Vout), and a drive circuit (1A) configured to drive the drive target transistor in an on-state all the time (first configuration).

Further, in the first configuration, the drive circuit (1A) may include a resistor (Ra) and a constant current source (CI1) that are configured to be connected in series between the application end of the input voltage (Vin) and a ground end, and a first node (N1) at which the resistor and the constant current source are connected to each other may be connected to a control end of the drive target transistor (P2) (second configuration).

Further, in the first configuration, the drive circuit (3A) may include a first resistor (Rb1) and a second resistor (Rb2) that are configured to be connected in series between the application end of the input voltage (Vin) and the ground end, a second node (N3) at which the first resistor and the second resistor are connected to each other may be connected to a control end of the drive target transistor (P), and a clamp element (Z1) may be connected to the control end (gate) and a first main electrode (source) of the drive target transistor (third configuration).

Further, in any one of the first to third configurations, the output transistor may include a PMOS transistor (P1) that has a source configured to be connected to the application end of the input voltage (Vin), and the drive target transistor may include a PMOS transistor (P2) that has a source configured to be connected to a drain of the output transistor and a drain configured to be connected to the feedback resistor (R1) (fourth configuration).

Further, in any one of the first to third configurations, the drive target transistor may include an NMOS transistor (NM2) that has a drain configured to be connected to the application end of the input voltage (Vin), and the output transistor may include an NMOS transistor (NM1) that has a drain configured to be connected to a source of the drive target transistor and a source configured to be connected to the feedback resistor (R1) (fifth configuration).

Further, in any one of the first to fifth configurations, the output transistor (P1) may include a CMOS (sixth configuration).

Further, in any one of the first to sixth configurations, the drive target transistor (P2) may include a DMOS (seventh configuration).

Further, in any one of the first to seventh configurations, a current mirror (CM) including the output transistor (P1) as a transistor on an output side may be further included (eighth configuration).

The present disclosure can be used for a linear power supply mounted on various devices.

What is claimed is:

1. A linear power supply comprising:
a feedback resistor;
an output transistor and a drive target transistor that are configured to be connected in series between an application end of an input voltage and the feedback resistor;
an error amplifier configured to drive the output transistor based on an error between a reference voltage and a feedback voltage that is generated by the feedback resistor based on an output voltage; and
a drive circuit configured to drive the drive target transistor in an on-state all the time.

2. The linear power supply according to claim 1, wherein
the drive circuit includes a resistor and a constant current source that are configured to be connected in series between the application end of the input voltage and a ground end, and
a first node at which the resistor and the constant current source are connected to each other is connected to a control end of the drive target transistor.

3. The linear power supply according to claim 1, wherein
the drive circuit includes a first resistor and a second resistor that are configured to be connected in series between the application end of the input voltage and a ground end,
a second node at which the first resistor and the second resistor are connected to each other is connected to a control end of the drive target transistor, and
a clamp element is connected to the control end and a first main electrode of the drive target transistor.

4. The linear power supply according to claim 1, wherein
the output transistor includes a P-channel metal-oxide-semiconductor transistor that has a source configured to be connected to the application end of the input voltage, and
the drive target transistor includes a P-channel metal-oxide-semiconductor transistor that has a source configured to be connected to a drain of the output transistor and a drain configured to be connected to the feedback resistor.

5. The linear power supply according to claim 1, wherein
the drive target transistor includes an N-channel metal-oxide-semiconductor transistor that has a drain configured to be connected to the application end of the input voltage, and
the output transistor includes an N-channel metal-oxide-semiconductor transistor that has a drain configured to be connected to a source of the drive target transistor and a source configured to be connected to the feedback resistor.

6. The linear power supply according to claim 1, wherein
the output transistor includes a complementary metal-oxide-semiconductor.

7. The linear power supply according to claim 1, wherein
the drive target transistor includes a double-diffused metal-oxide-semiconductor.

8. The linear power supply according to claim 1, further comprising:
a current mirror including the output transistor as a transistor on an output side.
